(19) United States
(12) Patent Application Publication
(10) Pub. No.: US 2025/0168634 A1
(43) Pub. Date: May 22, 2025

(54) COOPERATIVE DEVICE DISCOVERY AND SETUP

(71) Applicant: Lenovo (Singapore) Pte. Ltd., Singapore (SG)

(72) Inventors: Robert J. Kapinos, Durham, NC (US); Scott Li, Cary, NC (US); Russell S. Vanblon, Raleigh, NC (US); Robert James Norton, JR., Raleigh, NC (US)

(21) Appl. No.: 18/517,349

(22) Filed: Nov. 22, 2023

(51) Int. Cl. H04W 12/06; H04L 67/56; H04W 12/04

(52) U.S. Cl. CPC H04W 12/06; H04L 67/56; H04W 12/04

(57) ABSTRACT

A computer implemented method includes receiving a proxy request from a first device at a second device having a network connection to a setup device. Setup requests from the first device are forwarded to the setup device with the second device acting as a proxy for the first device. A setup communication is received from the setup device and includes setup information for the first device. The setup information is then forwarded to the first device allowing the first device to connect to a network.

### BACKGROUND

Connecting a device to a network may require a significant number of steps. With the advent of Internet of Things (IoT) devices, making such connections becomes even more difficult, as many of such device do not have control panels or interfaces to aid in making connections.

Prior solutions have involved equipping devices with management features and control panels or web management interfaces, which may not be desirable for simple devices such as light bulbs and light switches. Even the use of setup modes, where a device with a control interface to assist with setup, can be complicated and prone to failure.

### SUMMARY

A computer implemented method includes receiving a proxy request from a first device at a second device having a network connection to a setup device. Setup requests from the first device are forwarded to the setup device with the second device acting as a proxy for the first device. A setup communication is received from the setup device and includes setup information for the first device. The setup information is then forwarded to the first device allowing the first device to connect to a network.

### BRIEF DESCRIPTION OF THE DRAWINGS

FIGS. 1A, 1B, 1C, 1D, 1E, 1F, and 1G are a series of block diagrams illustrating steps performed in implementing a method of cooperative device discovery and setup according to an example embodiment.

FIG. 2 is a timing diagram illustrating functions performed and communications sent and received during performance of device discovery and setup according to an example embodiment.

FIG. 3 is a block diagram illustrating fields of a proxy request according to an example embodiment.

FIG. 4 is a block diagram illustrating fields of a credential communication according to an example embodiment.

FIG. 5 is a flowchart illustrating a second device performed method of acting as a proxy for discovery and setup of new devices according to an example embodiment.

FIG. 6 is a flowchart illustrating a first device performed method of using a proxy request for obtaining setup information to connect to a host according to an example embodiment.

FIG. 7 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Upon power-up, a first device, such as an internet of things (IoT) device, is not connected to a network. In order to establish such a connection, the first device will generate a proxy request for a second device to communicate to the network on behalf of the first device. The proxy request includes a first device address that identifies the first device, such as a peer-to-peer address, and information that identifies the proxy request as a request for the connection. The first device will link to a local connection and broadcast the proxy request to local devices via the local connection.

The local devices include a second device that receives the proxy request and forwards subsequent requests to a setup server that then provides credentials for use by the first device for connecting to a network. The second device may also broadcast information that it is handling the proxy request so that other devices do not also handle the proxy request. In one example, the setup server may be part of a host system to which the first device is to be connected. The setup server can be local or in the internet, as long as it has the property of having a findable name.

The second device establishes a connection to the setup server and asks for setup packets for first device with the peer to peer address. The second device may also be an IoT device and proxies the setup packets back to the device being set up. In one example, the second IoT device does not transfer any data out from the new IoT first device except its address. The second device does proxy all the setup information back to the first device.

Upon getting the setup packet, the first device configures itself. This typically involves joining to the local network with a first device network address if the setup packet contains credentials, such as an ID and password, to do so. The setup packet may include the network address or secrets required to access additional servers or networks to complete the configuration.

The first device may also include the ability to generically proxy configuration requests from other IoT devices once connected to the network.

In one example, the initial proxy request, or a follow up request upon learning that the second device is handling the initial proxy request, may include device identifiers or public keys that the setup server can validate with a private key to validate the first device. Validation may include contacting a further server, such as a server of the manufacturer of the first device to confirm the authenticity of the first device. Validation may occur prior to provision of the credentials.

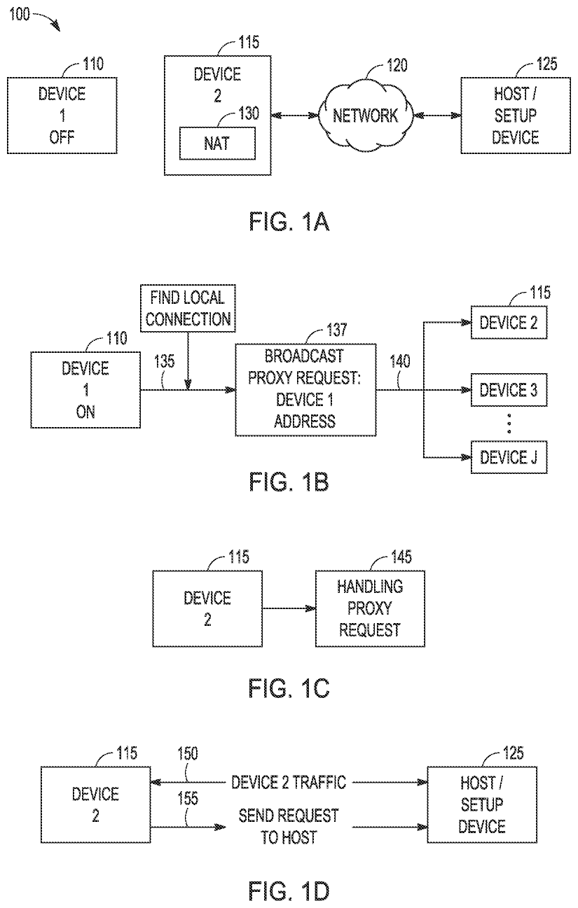

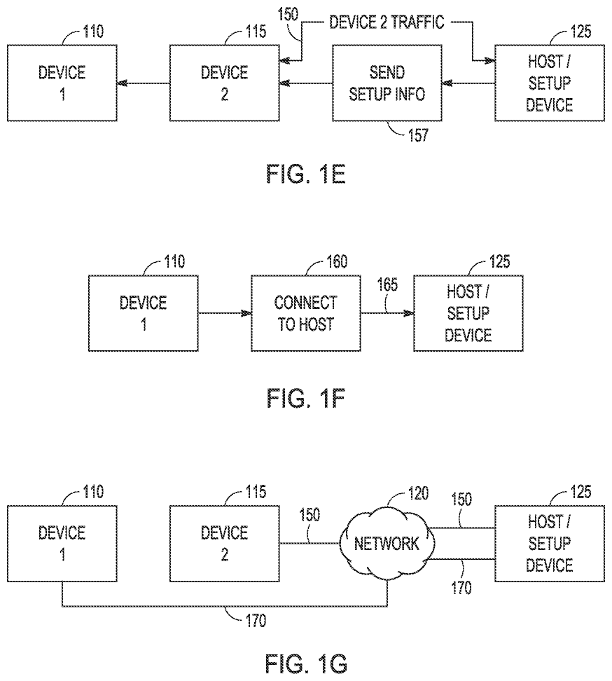

FIGS. 1A, 1B, 1C, 1D, 1E, 1F, and 1G are a series of block diagrams illustrating steps performed in implementing a method of cooperative device discovery and setup. FIG. 1A illustrates a device environment 100 that includes a first device 110, a second device 115, a network 120, and a host 125 which in one example includes a setup server. The second device 115 and host 125 are coupled via a network 120, such as the Internet or private network. network 120 may be wireless in one example.

First device 110 is shown as off and does not have a connection to any other devices. Second device 115 includes a network address translation (NAT) 130 capability that will be used to enable second device 115 to act as a proxy to first device 110 in order to obtain credentials for first device 110 to connect to the network 120 and host 125. Host 125 may include a setup server or device in one example that is capable of providing such credentials.

FIG. 1B illustrates first device 110 as turned on. First device 110 will first find a local connection 135 to enable peer-to-peer communications with other local devices, such as second device 115. First device 110 will then generate and broadcast a proxy request 137 to other local devices, such as second device 115, device 3 . . . device J.

FIG. 1C illustrates second device 115 receiving the proxy request 137 and broadcasting at 145 that the second device 115 is handling the proxy request. This ensure that other devices 3-J do not also attempt to handle the proxy request.

In one example, the proxy request 137 simply includes an address of the first device 110, such as a peer-to-peer address that identifies the first device, and an indication that the proxy request is a proxy request. The indication may consist of a defined field of one or two or more bits, or, even the words “PROXY REQUEST” to distinguish it from other types of communications.

FIG. 1D illustrates that second device 115 in communication with the host 125, such as via network 120. Second device 115 traffic is shown at communications 150 and involves communications between second device 115 and host 125 for purposes of establishing a connection. Traffic from the first device is sent by the second device impersonating the first device as communications 155, Communications 155 may utilize a different port from communications 150 but will still utilize address of the second device 115 for the communications.

In one example, second device 115 may know that it does not have a connection to the host 125, in which case, second device 115 will not accept the proxy request 137. In a further example, second device 115 may have accepted the proxy request 137, but fails to communicate properly with host 125, or otherwise does not receive a response from host 125. The second device 115 may timeout after a selected period of time and reply to the first device 110 that the proxy request 137 was not handled, enabling first device 110 to re-broadcast the proxy request 137 for handling by another device.

If no device is able to act as a proxy within a selected time out period, the first device 110 may refrain from further trying to connect to the network 120 until turned off and powered on again, or after a longer retry timeout period.

FIG. 1E illustrates the host 125, after receiving the proxy request from the second device 115, generating credentials for first device 110. The host 120 may generate setup information 157 that is forwarded back to the second device 115 for forwarding to the first device. The second device 115 may perform network address translation at 115 to translate the address of the second device 115 back to the address of the first device 110 for communication over the local connection 135.

FIG. 1F illustrates the first device 110 after having received the credentials. First device 110 will use the credentials to access the network 120 to communicate directly, via communications 170 to the host 125 as shown in FIG. 1G.

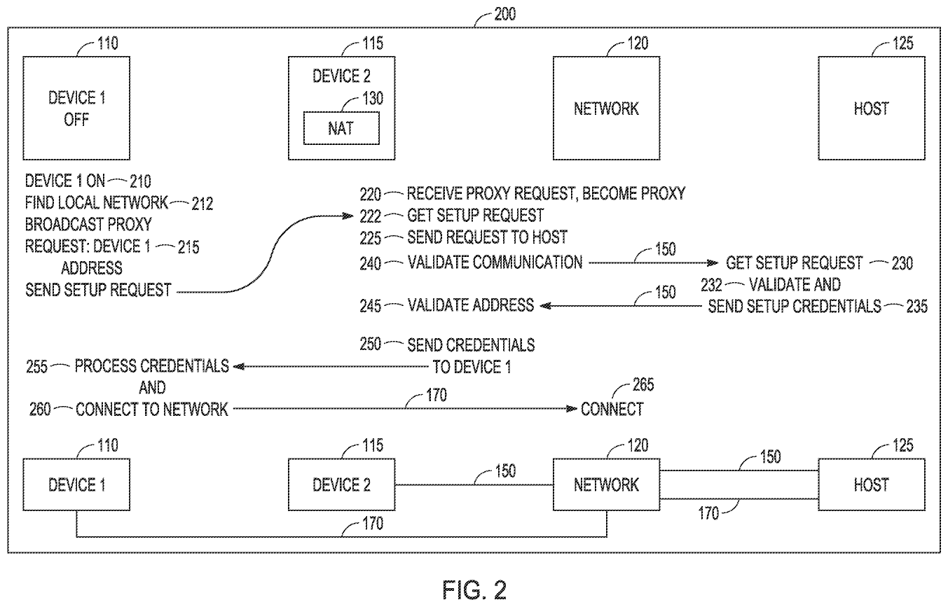

FIG. 2 is a timing diagram illustrating functions performed and communications sent and received at 200 during performance of device discovery and setup. In one example, first device 110 is in an off state. Device 110 may be a smart lightbulb, a lock, a camera, a security sensor, a thermostat, a home appliance, a smart voice controller, or any other device having the ability to connect to a network and interact with a host device. Such devices may not have a user interface to aid in connecting to a network, so should be able to do so automatically.

At 210, first device 110 is turned on. Turning on first device 110 may be done by simply coupling the first device 110 to electrical power, or even switching on power if first device 110 is battery powered. In one example, first device 110 is a smart lightbulb having an Edison connector and is powered on by screwing the lightbulb into a powered socket or turning on the socket via a separate switch following screwing in of the lightbulb.

Powering of first device 110 causes first device 110 to first find a local network at 212 and broadcast a proxy request that includes an address of the first device 110 at 215. The address may be a peer-to-peer address which identifies the first device 110.

At 220, second device 115 receives the proxy request and decides to handle the proxy request, becoming a proxy. If second device 115 does not have a network connection, it may decline to handle or ignore the proxy request. Second device 115 may broadcast a message indicating that the proxy request is being handled by second device 115. Other devices that may have received the proxy request will decline to process the proxy request on receiving the broadcast by second device 115.

At 220, the second device may receive a setup request from first device 110. Second device 115 will then use its existing connection 150 via network 120 to host 125 to forward or send setup requests at 225 to the host 125. The existing connection utilizes already established communication ports in second device 115 and host 125 and also utilizes the address of the second device 115.

Host 125 receives the setup request at 230 and validates the request at 232. Validation may involve utilizing the first device 110 media control address to identify the first device 110 as a smart device that is allowed to connect to host 125. In some examples, the first device 110 address may be sufficient to determine the origin of the first device and identify what type of device it is by connecting to third party data sources, such as the manufacturer of the first device 110. In further examples, the proxy request may also include further identifying information, such as a model and serial number of the first device to aid in validation.

Host 125 may then generate setup credentials that enable the first device 110 to connect to host 125 via network 120 and communicate or send the credentials at 235 back to the second device 115, using the established connection and the second device 115 network address. Second device 115 validates the communication as coming from host 125 and sends the credentials to the first device 110 at 250. If a wired connection exists, the credentials may be directly sent to first device 115.

First device 110 processes the credentials at 255 and uses the credentials at 260 to connect 265 to the network 120 and host 125 using a first device network address, creating a separate connection 170 such that the peer-to-peer connection to second device 115 is no longer needed.

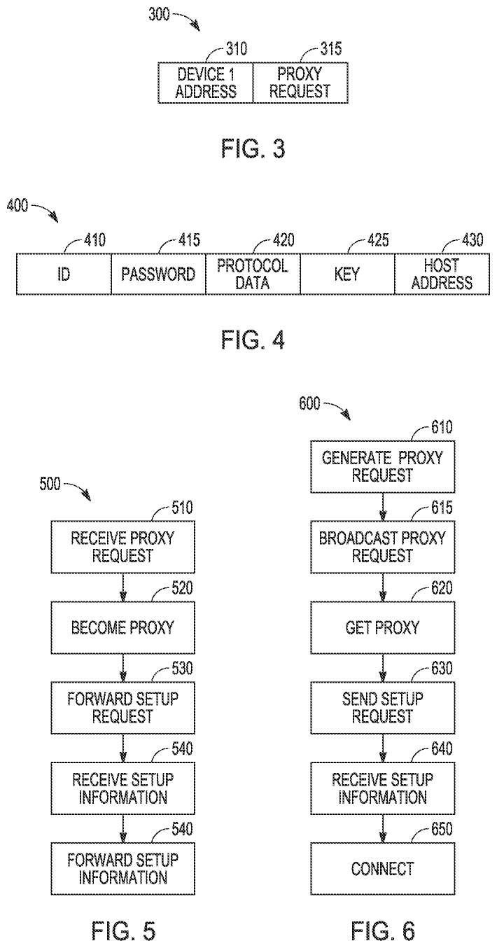

FIG. 3 is a block diagram illustrating fields of a proxy request 300. In one example, proxy request 300 includes an address 310 of the first device 110 and a proxy request field 315 identifying the proxy request as a proxy request. The address 310 may be peer-to-peer address. The proxy request field 315 may be a single bit, or multiple bits or bytes that are interpreted by a receiving device as indicative of the proxy request 110 being a proxy request for processing to obtain credentials to allow the first device to establish a connection to network 120. Second device 115, that receives the proxy request, will have program code, such as in NAT 130, that operates as a proxy for first device 110 by recognizing the request and processing the request to send and forward communications to provide the credentials to the first device 110.

FIG. 4 is a block diagram illustrating fields of a credentials communication 400. Typical credentials may include a ID 410 and password 415. Other fields may include protocol data 420, key 425, and a host 125 address 430. Protocol data 420 may specify the type of communication protocol to utilize for communicating with host 125, such as HTTPS or other communication protocol. Key 425 may include one or more cryptographic keys for use in encrypting and decrypting communications, such as public/private keys.

FIG. 5 is a flowchart illustrating a second device 115 performed method 500 of acting as a proxy for discovery and setup of new devices. Method 500 begins at operation 510 by receiving a proxy request 300 from the first device 110 at the second device 115 having a network connection 120 to a setup device or server, such as setup host 125, the proxy request 300 including an address 310 of the first device 110. Operation 510 may also cause the second device to broadcast information confirming the second device is handling the proxy request.

Operation 520 accepts the proxy request 300 and the second device becomes a proxy for the first device.

A request for a setup communication is received at the second device from first device and is forwarded to the setup host by the second device acting as a proxy for the first device. The setup communication 400 includes information on how to contact the host 125. The setup information request comprises identification of the first device and any necessary credentials for communicating to the setup host 125 or other servers coupled to the network 120. In one example, the setup information includes log in credentials, protocol information, an IP address, or information allowing obtaining an IP address for first device 110, and a public key.

Operation 540 receives the setup information from the setup host 125 at the second device. In one example, the setup information comprises an ID, password, networking protocol data and a setup device address. Operation 550 translates the address of the second device used for communication with the setup host to the address of the first device and forwards the setup information to the first device. The communication may also be validated at operation 540 prior to forwarding the setup information.

In one example, the proxy request is received wirelessly, and the second device 115 is wirelessly coupled to the setup host device. In one example, the second device 115 comprises a network address translation proxy.

FIG. 6 is a flowchart illustrating a first device 110 performed method 600 of using a proxy request 300 for obtaining setup information to connect to host 125. Operation 610 begins by generating a proxy request that identifies the first device 110 and includes information identifying the proxy request as a request for another device, such as second device 115, to contact the host device 125 for the first device.

Operation 615 broadcasts the proxy request. The proxy request may be broadcast wirelessly or on a shared wired media.

In one example, the proxy request may also include first device identification information, such as device name, serial number, and manufacturer. Such information may be used by proxy candidates to validate the first device 110 prior establishing a role as proxy.

At operation 620 the second device is established as the proxy for the first device. Subsequent requests made by the first device are sent to the second device instead of being broadcast to all local devices. The connection between the first and second device may be a peer-to-peer network, an ad hoc private network, an out of band conversation, or a temporary low privilege join to an existing network. At operation 630, the first device makes a setup request to the second device. At operation 640, the first device obtains setup information back from the second device. At operation 650, the first device connects to the network and afterwards does not communicate to the second device.

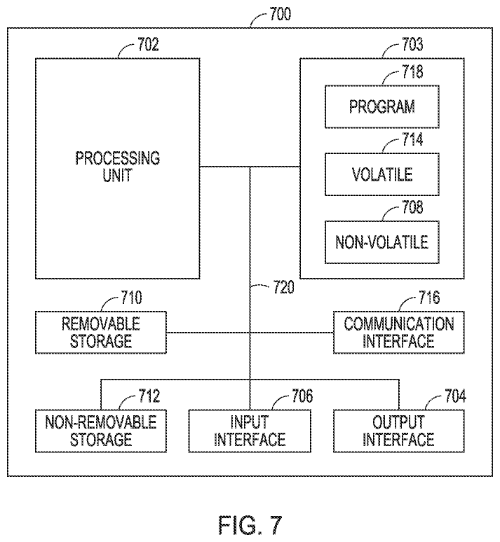

FIG. 7 is a block schematic diagram of a computer system 700 to implement one or more devices and their corresponding functions described herein, and for performing methods and algorithms according to example embodiments. All components need not be used in various embodiments. For example, a smart lightbulb would likely include only circuitry needed to perform the limited connection methods and control of the lightbulb based on commands received from the host device, such one, off, dim, etc. Devices having more complex functions may utilize more components of system 700.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### Examples

1. A computer implemented method includes receiving a proxy request from a first device at a second device having a network connection to a setup device. Setup requests from the first device are forwarded to the setup device with the second device acting as a proxy for the first device. A setup communication is received from the setup device and includes setup information for the first device. The setup information is then forwarded to the first device allowing the first device to connect to a network.
2. The method of example 1 wherein the proxy request is received wirelessly.
3. The method of any of examples 1-2 wherein the second device is wirelessly coupled to the setup device.
4. The method of any of examples 1-3 wherein the setup information includes credentials for setting up a wireless connection between the first device and a network
5. The method of any of examples 1-4 wherein the setup information includes log in credentials, protocol information, and a public key.
6. The method of the any of examples 1-5 wherein the second device includes a network address translation proxy.
7. The method of any of examples 1-6 wherein the second device is configured to broadcast information confirming the second device is handling the proxy request or if unable to connect to the setup device, provide an indication back to the first device that the second device is not handling the proxy request.
8. The method of any of examples 1-7 wherein the proxy request includes a peer-to-peer address of the first device.
9. The method of example 8 wherein the setup information enables the first device to obtain a public internet protocol (IP) address.
10. The method of any of examples 1-9 wherein the setup information includes networking protocol data and a setup device address.
11. The method of example 10 and further including validating the setup communication prior to forwarding the setup information.
12. The method of any of examples 1-11 wherein setup request is forwarded to the setup device using an address of the second device acting as a proxy for the first device.
13. The method of any of examples 1-12 wherein the proxy request includes information identifying the proxy request as a proxy request for a connection.
14. A computer implemented method includes generating a proxy request at a first device, the proxy request identifying the first device and including information identifying the proxy request as a proxy request for a second device to request setup information corresponding to a host device, broadcasting the proxy request, receiving the setup information from the second device. and connecting to a network and host device based on the setup information.
15. The method of example 14 wherein the setup information includes networking protocol data and a host device address.
16. The method of any of examples 14-15 wherein the proxy request is broadcast wirelessly.
17. The method of any of examples 14-16 wherein the setup information includes credentials for setting up a wireless connection between the first device and the host device.
18. The method of any of examples 14-17 wherein the proxy request is a broadcast proxy request that includes log in credentials and a public key.
19. A device includes a processor and a memory device coupled to the processor and having a program stored thereon for execution by the processor to perform operations including receiving a proxy request from a first device at a second device having a network connection to a setup host, the proxy request including an address of the first device, forwarding a setup request to the setup device, receiving a setup communication from the setup device that includes setup information for the first device, and forwarding the setup information to the first device.
20. The device of example 19 wherein the setup information includes credentials for setting up a wireless connection between the first device and the setup device, wherein the proxy request is a broadcast proxy request, and wherein the operations further include broadcasting information confirming the second device is handling the proxy request.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a proxy request from a first device at a second device having a network connection to a setup device;
forwarding setup requests from the first device to the setup device;
receiving a setup communication from the setup device that includes setup information for the first device; and
forwarding the setup information to the first device.

2. The method of claim 1 wherein the proxy request is received wirelessly.

3. The method of claim 1 wherein the second device is wirelessly coupled to the setup device.

4. The method of claim 1 wherein the setup information comprises credentials for setting up a wireless connection between the first device and a network

5. The method of claim 1 wherein the setup information includes log in credentials, protocol information, and a public key.

6. The method of the claim 1 wherein the second device comprises a network address translation proxy.

7. The method of claim 1 wherein the second device is configured to broadcast information confirming the second device is handling the proxy request or if unable to connect to the setup device, provide an indication back to the first device that the second device is not handling the proxy request.

8. The method of claim 1 wherein the proxy request includes a peer-to-peer address of the first device.

9. The method of claim 8 wherein the setup information enables the first device to obtain a public internet protocol (IP) address.

10. The method of claim 1 wherein the setup information comprises networking protocol data and a setup device address.

11. The method of claim 10 and further comprising validating the setup communication prior to forwarding the setup information.

12. The method of claim 1 wherein setup request is forwarded to the setup device using an address of the second device acting as a proxy for the first device.

13. The method of claim 1 wherein the proxy request includes information identifying the proxy request as a proxy request for a connection.

14. A computer implemented method comprising:
generating a proxy request at a first device, the proxy request identifying the first device and including information identifying the proxy request as a proxy request for a second device to request setup information corresponding to a host device;
broadcasting the proxy request;
receiving the setup information from the second device; and
connecting to a network and host device based on the setup information.

15. The method of claim 14 wherein the setup information comprises networking protocol data and a host device address.

16. The method of claim 14 wherein the proxy request is broadcast wirelessly.

17. The method of claim 14 wherein the setup information comprises credentials for setting up a wireless connection between the first device and the host device.

18. The method of claim 14 wherein the proxy request is a broadcast proxy request that includes log in credentials and a public key.

19. A device comprising:
a processor; and
a memory device coupled to the processor and having a program stored thereon for execution by the processor to perform operations comprising:
receiving a proxy request from a first device at a second device having a network connection to a setup host, the proxy request including an address of the first device;
forwarding a setup request to the setup device;
receiving a setup communication from the setup device that includes setup information for the first device; and
forwarding the setup information to the first device.

20. The device of claim 19 wherein the setup information comprises credentials for setting up a wireless connection between the first device and the setup device, wherein the proxy request is a broadcast proxy request, and wherein the operations further comprise broadcasting information confirming the second device is handling the proxy request.
